(19) United States
(12) Patent Application Publication
(10) Pub. No.: US 2017/0268954 A1
(43) Pub. Date: Sep. 21, 2017

(54) Pipeline Wireless Sensor Network

(71) Applicant: Rheidiant, Inc., Houston, TX (US)

(72) Inventor: Murat Ocalan, Houston, TX (US)

(21) Appl. No.: 15/510,922

(22) PCT Filed: Sep. 22, 2015
(86) PCT No.: PCT/US15/51350

§ 371 Date: Mar. 13, 2017

Related U.S. Application Data
(60) Provisional application No. 62/056,540, filed on Sep. 28, 2014.
(60) Provisional application No. 62/074,210, filed on Nov. 3, 2014.

(51) Int. Cl. G01M 3/00; H04W 84/18

(52) U.S. Cl. CPC G01M 3/00; H04W 84/18

(57) ABSTRACT

A robust pipeline leak detection system allows the operator to take timely corrective action to the problem, minimizing leakage of the fluids contained in the pipeline to the environment. The wireless sensor network system disclosed in this invention detects the presence of a leak by various sensors including acoustic sensors distributed along a pipeline system. The sensors are connected to the wireless sensor network. An advantage of this system is that it is possible to deploy the leak detection system on existing buried pipelines without significant excavation.

### BACKGROUND

This disclosure relates to pipeline systems. More specifically the disclosure relates to leak detection systems utilized in pipeline systems.

During the operation of pipeline systems the flow of the conveyed fluids is monitored using various sensors measuring parameters such as pressure, flow rate and temperature. Using these instruments the operator of the pipeline system can evaluate the health of the systems within the accuracy of the measurements and uncertainty of the flow parameters. It is, however, not possible to detect all potential leaks. Further instrumentation, therefore, providing a high level of sensitivity to potential problems can extend the safety of pipeline system operations.

### BRIEF DESCRIPTION OF THE DRAWINGS

FIG. 1 shows an example wireless sensor node installed near a pipe.

FIG. 2 shows example electrical architecture of the wireless sensor node of FIG. 1.

FIG. 3 shows a wireless sensor node placed in proximity to a pipeline.

FIG. 4 shows another embodiment of a wireless sensor node.

FIG. 5 shows an embodiment of a sensor node having a hollow coupling rod.

FIG. 6 shows an embodiment of a wireless sensor node including a pipeline warning sign.

FIG. 7 shows a wake/sleep cycle for wireless sensor nodes illustrated with a flow diagram.

### DETAILED DESCRIPTION

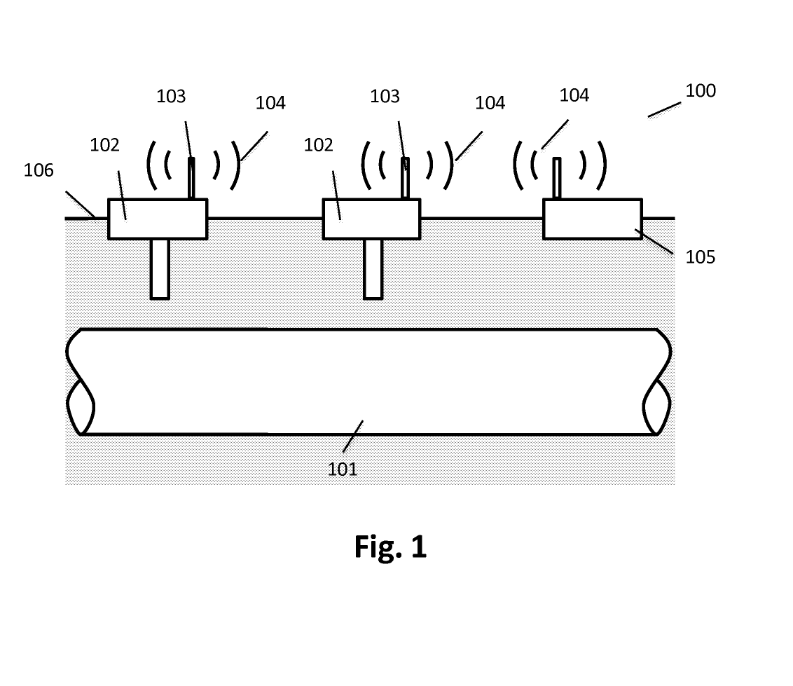

Referring to FIG. 1, a leak detection system 100 according to the present disclosure may be used with a pipeline system 101. The pipeline system 101 may comprise a pipeline constructed to transmit a fluid from one location to another, or it may be a combination of pipes forming a network transmitting fluid to and from a plurality of locations. The pipeline system 101 is typically buried below the ground surface 106 in order the protect it from damage.

Some non-limiting examples of pipeline systems include hydrocarbon pipelines, water distribution pipeline network systems, chemical pipelines, and sewer networks.

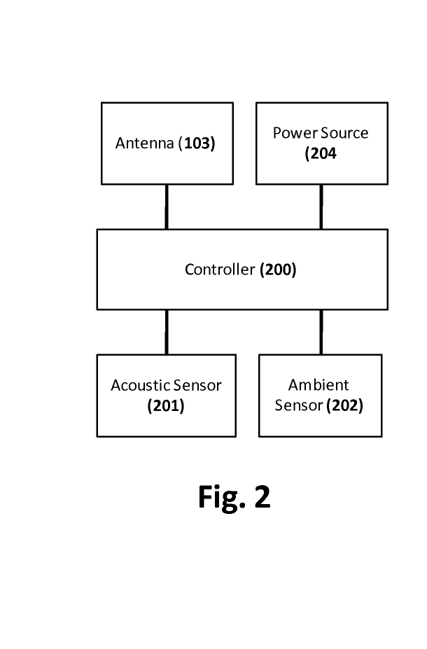

In case of a containment failure in the pipeline system 101 causing a leak, it is important to detect such leak and begin corrective actions as soon as possible. The leak detection system 100 disclosed herein facilitates prompt detection of containment failure by locating a plurality of wireless sensor nodes 102 at various locations along the pipeline system 101; each wireless sensor node 102 being in proximity to the pipeline system 101. The wireless sensor nodes 102 may be placed with small enough spacing between them such that each wireless sensor node 102 is in the wireless signal 104 range of at least one other wireless sensor node's 102 wireless signal 104. The foregoing spacing between wireless sensor nodes 102 enables creating a wireless sensor network, for example a mesh network. The wireless sensor nodes 102 will be explained in more detail below with reference to FIGS. 2 through 6.

Communication of commands and data in the wireless sensor network may be relayed from one wireless sensor node 102 to another. Also located in the wireless sensor network is a gateway node 105 which has a) connectivity with one or more wireless sensor nodes 102 in the wireless sensor network, and b) signal connectivity external to the wireless sensor network, for example, with an operations control center having equipment (not shown) therein for monitoring the wireless sensor network. The out-of-network connectivity may be established by various communication means for example and without limitation, cellular communication networks, Ethernet, optical fiber connection and satellite communication devices.

Because the wireless sensor nodes 102 are typically not externally wired for electrical power, they may, for example, use battery and/or solar power. In some embodiments, the wireless sensor nodes 102 may be programmed to maintain a low-power “sleep” mode as much as possible to extend battery life.

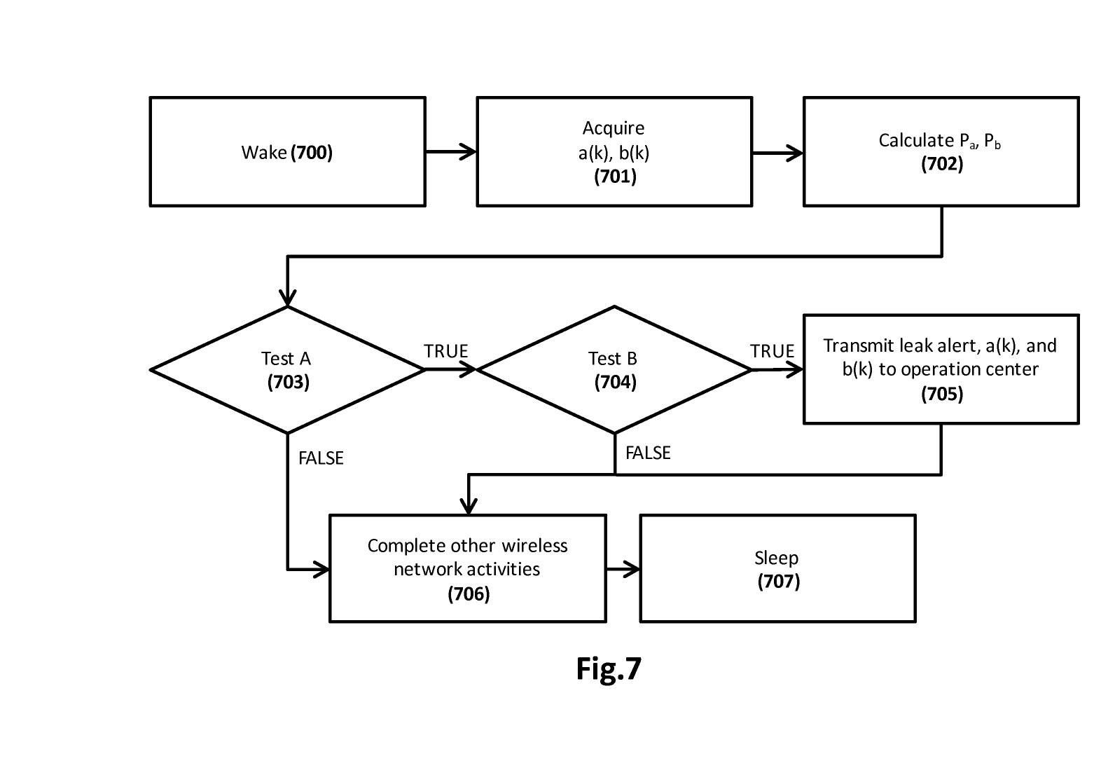

In an example embodiment of a monitoring scheme, all the wireless sensor nodes 102 in the wireless sensor network switch on (“wake up”) and make measurements, e.g., of ambient acoustic signals, to detect the possible presence of a leak in the pipeline system 101. These measurements may be locally post-processed in each wireless sensor node 102 to minimize volume of data transfer on the wireless sensor network. For example, a wireless sensor node 102 may calculate the power of the signal measured and compare this to a locally stored threshold. If the signal power is determined to be more than the locally stored threshold, the wireless sensor node 102 will transmit these measurements to the wireless sensor network. Conversely, if the power of the locally measured signal is less than the threshold, the wireless sensor node 102 may be programmed not to transmit the measurements to conserve its own battery power and that of the other wireless sensor nodes 102 on the wireless sensor network. Following post-processing, each wireless sensor node 102 may have programmed therein a preselected duration window of time in which the wireless sensor node 102 may transmit its measurements and/or the results of its post-processing to another wireless sensor node 102 in proximity thereto (typically the closest or neighboring wireless sensor node 102). The transmitted data may then be relayed in the wireless sensor network from one wireless sensor node 102 to another until the data reach the gateway node 105, which in turn communicates the data out of the wireless sensor network, e.g., to an operations control center. The determination of a leak by a wireless sensor node 102 is further described with reference to FIG. 7.

In some wireless sensor networks, the wireless sensor nodes 102 may be programmed to operate at a low power level sleep mode during standby until detection of a wireless signal transmission from another wireless sensor node 102. Detection of such signal transmission triggers the wireless sensor node 102 to wake up and initiate wireless communication and/or other functions of the wireless sensor node 102.

The information communicated by each wireless sensor node 102 may be raw sensor data, compressed data, or results of post-processing which may indicate a leak being present.

During the time when any one or more wireless sensor nodes 102 are “awake”, the operator of the wireless sensor network may be enabled to send commands to each wireless sensor node 102 to acquire sensor data or send new software or parameters using the gateway node 105.

It may be desirable to synchronize timing between wireless sensor nodes 102 during some or all wake up intervals so that subsequent wake up triggering events are better timed for the wireless sensor network.

It may be desirable to place a wireless sensor node 102 such that it is in the range of both adjacent wireless sensor nodes 102 and further wireless sensor nodes adjacent to the adjacent wireless sensor nodes 102. Such spacing of the wireless sensor nodes 102 may provide a desirable signal communication redundancy to ensure that a communication failure in any one wireless sensor node 102 is unlikely to interrupt communication within the wireless sensor network.

Because typical pipeline systems are substantially linear, it may be practical to use an antenna 103 for each wireless sensor node 102 that is directional and have its highest gain aligned along the principal direction of the pipeline system 101. The antenna 103 may be disposed above the ground surface 106 to facilitate wireless communication.

Referring to FIG. 2, the electrical architecture of each wireless sensor node 102 may include a controller 200 electrical assembly. The controller 200 may consist of, including and without limitation a microcontroller, microprocessor, field programmable gate array (FPGA) application specific integrated circuit (ASIC) or other programmable integrated circuitry and some form of data storage or memory (volatile and/or non-volatile). The controller 200 may include real-time clock circuitry (not shown), for example, a global positioning system satellite signal receiver, and interfaces to transmit data to and from other devices within the wireless sensor node 102.

The wireless sensor node 102 may be powered by a power source 204. Some non-limiting examples of power sources are batteries such as lithium batteries, supercapacitors, photovoltaic cells, thermoelectric generators, vibration energy harvesters, fuel cells, thermal batteries or any combination of the foregoing power sources.

The controller 200 may be in signal communication with the antenna 103 to increase the signal strength of transmitted and received signals from other wireless sensor nodes 102 and/or the gateway node 105.

The leak detection system (100 in FIG. 1) may use acoustic measurements to detect the presence of fluid discharge from the pipeline system 101. The wireless sensor node 102 may include two sensors for this purpose: an acoustic sensor 201 and an ambient sensor 202. The acoustic sensor 201 may be acoustically coupled with the pipeline system (101 in FIG. 1) to detect acoustic waves propagating through the pipeline system (101 in FIG. 1). While the ambient sensor 202 may have some acoustic coupling with the pipeline system 101, such coupling is to a lesser degree and therefore the ambient sensor 202 may be used to sense the background acoustic environment. By using an acoustic sensor 201 and an ambient sensor 202, it is possible to substantially determine if an acoustic wave is received from the pipeline system (101 in FIG. 1) or another source in the ambient.

The typical source of the acoustic waves in a leaking pipeline system is from fluids, which are under pressure in the system, escaping to the environment. The acoustic waves normally propagate through the pipeline system (101 in FIG. 1) the fluid contained in the pipeline system, and the medium surrounding the pipeline system.

The acoustic sensor 201 can detect fluid escape sound traveling through the soil covering the pipeline system. The range of the measurement of such sound by the acoustic sensor 201 is enhanced by the presence of pipeline system 101 because pipes create an effective waveguide allowing for the acoustic waves to propagate much further than they do in soil.

The controller 200 filters the analog signal generated by the acoustic sensor 201 and the ambient sensor 202 and converts the analog signal to a digital signal using one or more analog to digital converters (not shown separately) which may form part of the controller 200. The digital signals may in turn be processed by the controller 200 or any other processor (not shown) in the wireless sensor node 102 to analyze detected acoustic energy for the presence of leaks.

Some non-limiting examples of the acoustic sensor 201 and ambient sensor 202 are geophones, hydrophones, microphones and accelerometers.

The controller 200 may process acoustic measurements from the acoustic sensor 201 concurrently with processing signals from the ambient sensor 202 and previous measurements made at the location of the wireless sensor node 102 since other acoustic sources near the wireless sensor node 102 may lead to a false positive identification of a leak. The ambient sensor 202 is desirable to use in the process of detecting leaks however it is not essential. The process of detecting leaks with and without the ambient sensor 202 is described further with reference to FIG. 7.

The electrical architecture of the gateway node (105 in FIG. 1) may be similar to that of the wireless sensor node 102. However, in addition to the controller 200 of the wireless sensor node 102, the controller 200 of the gateway node (105 in FIG. 1) may include capability to communicate out-of-network, as previously explained, typically to an operations monitoring center for the pipeline system (101 in FIG. 1). The gateway node 105 may contain an acoustic sensor 201 and an ambient sensor 202 similar to those in any or all of the wireless sensor nodes 102 and such sensors may be used to detect leaks in a similar manner to a wireless sensor node 102. Alternately, the gateway node 105 may not contain such sensors and may function merely as a communication link to connect communication from the wireless sensor nodes 102 to any one or more systems outside of the network.

Other sensors may also be used on the wireless sensor node 102 to detect leaks. Some examples of other sensors are temperature sensors, optical cameras, infrared cameras, infrared sensors, resistivity sensors and electrochemical sensors.

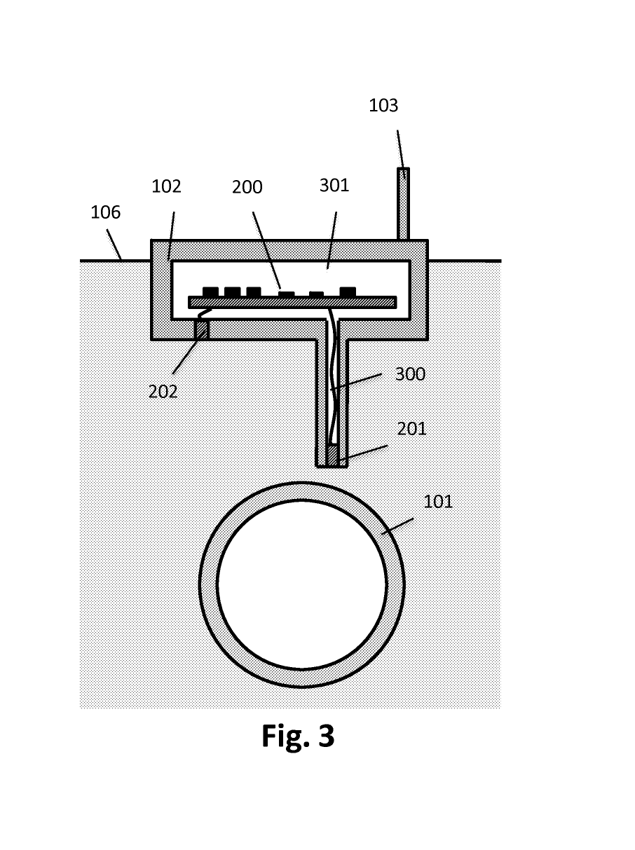

Referring to FIG. 3, the wireless sensor node 102 is placed in proximity to the pipeline system 101. The controller 200 may be placed in a sealed enclosure 301 in the wireless sensor node 102. The acoustic sensor 201 is placed in close proximity to the pipeline system 101 in order to increase its sensitivity to acoustic waves propagating along the pipes. The acoustic sensor 201 is in signal communication 300, e.g., by electrical and/or optical signal conduction to the controller 200. The ambient sensor 202 is placed in a similar manner; however, it may be placed at a greater distance away from the pipeline system to have less sensitivity to acoustic waves propagating in the pipes.

As illustrated in FIG. 3, the wireless sensor node 102 may be placed in proximity of the pipeline system 101 without requiring significant excavation. This is useful design feature of the leak detection system (100 in FIG. 1) as its installation thereby creates only a small risk of damage to the pipeline system 101.

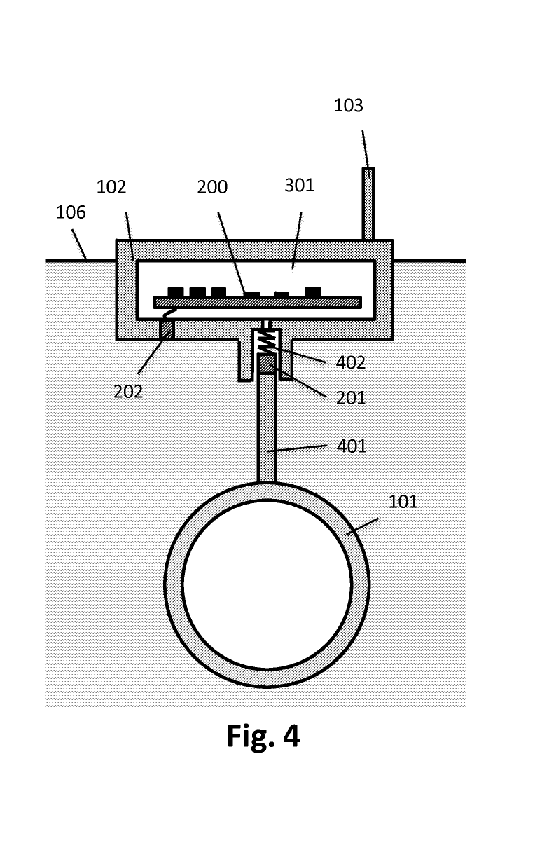

Referring to FIG. 4, in another embodiment of the wireless sensor node 102, in order to obtain better acoustic coupling between the acoustic sensor 201 and the pipeline system 101 a coupling rod 401 may be used. The coupling rod 401 may be inserted until it makes contact with the pipeline system 101. Once the remainder of the wireless sensor node 102 is installed the coupling rod 401 may be urged against the pipeline system 101 by a biasing device such as a spring 402.

The acoustic sensor 201 may be affixed to the coupling rod 401 with mechanical means such as a screw and/or an adhesive to increase the acoustic coupling between the coupling rod 401 and the acoustic sensor 201.

It is also possible to place the acoustic sensor 201 in contact with the pipeline system 101 and use the coupling rod 401 to urge the sensor 201 against the pipeline system 101.

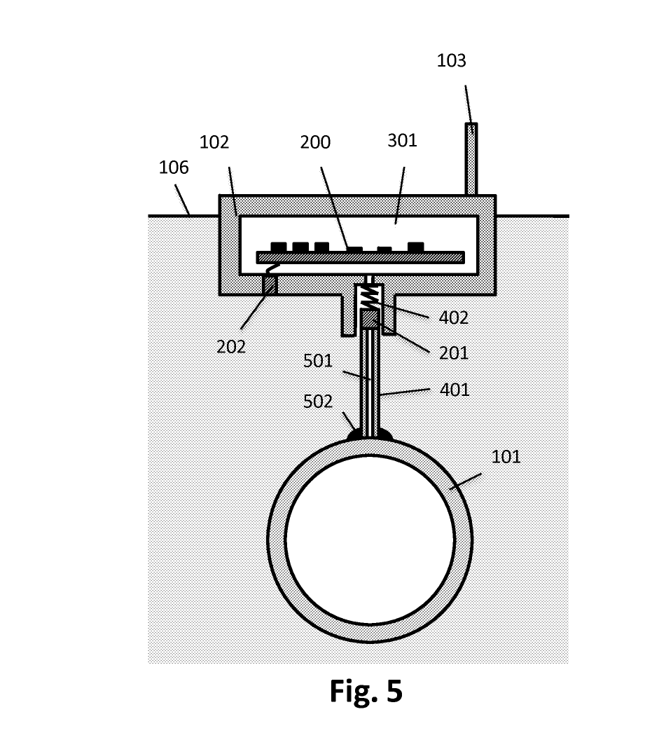

Referring to FIG. 5, in another embodiment a hollow coupling rod 401 may be used to connect the acoustic sensor 201 to the pipeline system 101. A conduit 501 may pass through the interior of the coupling rod 401 to minimize the load required for inserting the coupling rod 401. This also minimizes the load placed on the pipeline system 101, especially during the final stages of the insertion. After the coupling rod 401 is inserted, an adhesive 502 such as an epoxy may pumped through the conduit 501 and placed between the coupling rod 401 and the pipeline system 101, effectively increasing the acoustic coupling between the foregoing components. In other embodiments, one or more magnets (not shown) may be used on the coupling rod 401 to establish a connecting force between the coupling rod 401 and the pipeline system 101.

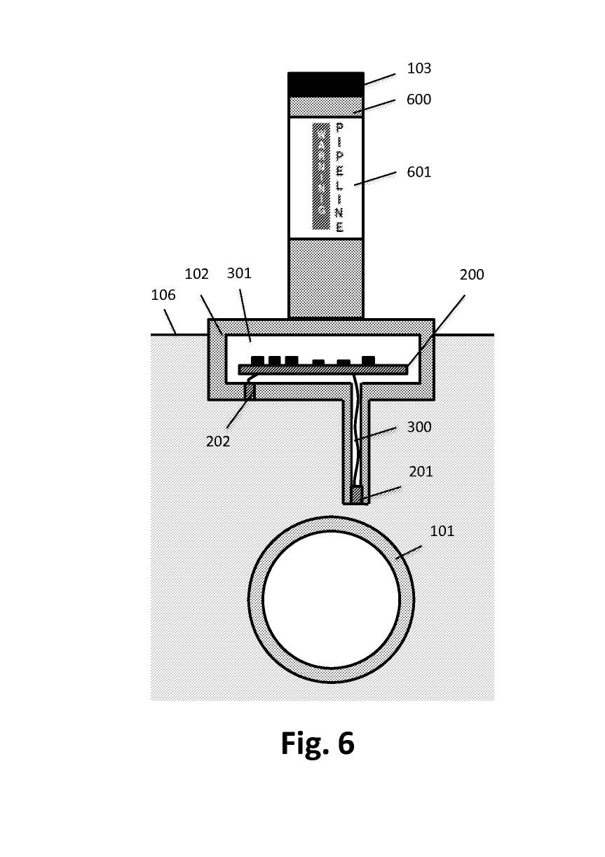

Referring to FIG. 6, in another embodiment the wireless sensor node 102 may include a pipeline warning sign 600 disposed above the ground surface 106. A warning sign may consist of a post and a plate containing warning message affixed to the post. In other embodiments, the warning message may be written on the post. Pipeline warning signs are normally placed proximate to a buried pipeline to warn people with visual indication 601 of the presence of the pipeline 101 underground, reducing the chance of accidental damage to the pipeline 101 caused by nearby excavation or construction. Typical installation spacing of the warning signs 600 may be similar to that of the wireless sensor nodes 102. Therefore it may be advantageous to connect the warning sign 600 to above-ground components of each wireless sensor node 102 to minimize cost and increase functionality. Furthermore the warning sign 600 may encase some of the necessary components of the wireless sensor node 102, such as the antenna 103 as illustrated in the figure, or other sensors. It may be advantageous to place the antenna 103 at a higher elevation to maximize its range, especially in geographic areas where heavy snow cover is expected. In some embodiments, the height of the warning sign 601 may be used to place the antenna 103 on or in the sign.

Referring to FIG. 7, leak detection is made using the measurements from the acoustic sensor 201, and the ambient acoustic sensor 202. In FIG. 7, a typical wake 700-sleep 707 cycle of the wireless sensor node 102 is illustrated with a flow diagram. The wireless sensor nodes 102 are typically operated in two modes: awake and sleep modes. In the sleep mode, some of the circuitry in the node 102 is turned off in order to conserve battery power. In awake mode, the nodes 102 acquire data, transmit and receive data and/or commands on the wireless sensor network. In the present embodiment after waking 700 from sleep mode, the wireless sensor node 102 acquires data from the acoustic sensor 201 and the ambient acoustic sensor 202. In this acquisition the acoustic sensor 201 is sampled N number of times and a discrete-time signal represented by a(k) is acquired, where k is the time index of the signal and ranges between 1 and N. Similarly the ambient acoustic sensor 202 is sampled to obtain a discrete-time signal represented by b(k). In the next step 702, average power of each discrete-time signal a(k) and b(k) is calculated. The average power of a discrete-time signals x(k) may be defined as Pₓ=(1/N) Σₖ₌₁^{N}[x (k)]². Pₐ and P_{b} represent the average power of signals a(k) and b(k), respectively. The average power of the two signals are used to determine if a leak alert needs to be issued by the wireless sensor node 102 by first conducting Test A 703 and then Test B 704. In one embodiment Test A consists of comparing Pₐ and P_{b} against threshold values Tₐ(t) and T_{b}(t) respectively. The threshold values are predetermined and may be stored in a non-volatile memory space in the wireless sensor node 102, e.g., in flash memory. The threshold values are time-dependent as they account for expected background noise at the location of the particular wireless sensor node at a given time. For example, if traffic noise from a nearby highway is present at the wireless sensor node location, the threshold value during rush hour will be different than the threshold value at other times. In the present embodiment Test A is found to be true if Pₐ>Tₐ(t) and P_{b}<T_{b}(t). Otherwise Test A is false. Test B is typically utilized to avoid taking up wireless sensor network bandwidth based on a single calculation. An errant calculation may be caused by a local disturbance such as a train or a vehicle passing near the wireless sensor node 102 and it is beneficial to avoid false leak alerts based on these local events. In this embodiment Test B is the found to be true if Pₐ>Tₐ(t) and P_{b}<T_{b}(t) at the previous wake-sleep cycle. Otherwise Test B is false. Even though the same criteria may be used on Tests A and B, since Test B tests for the criteria at the previous wake-sleep cycle, it can be used to screen for temporary disturbances if the wake-sleep cycle frequency is low enough (for example once every 10 minutes). If Test B is true, then the wireless sensor node 102 transmits a leak alert and the acquired data associated with this leak alert, and a(k) and b(k) through the wireless sensor network to the operation control center. At the operation control center, the user can determine an appropriate response to a leak alert by evaluating the acquired data further. Even though this completes the evaluation necessary for determining a local leak at a wireless sensor node 102, the wireless sensor node may need to remain in awake mode further to relay data or commands transmitted from other nodes on the network. Once this step (706) is complete, the node 102 goes to sleep mode 707.

In another embodiment the wireless sensor node 102 calculates 702 a reduced noise signal, c(k) based on the measurements from the acoustic sensor 201 and the ambient acoustic sensor 202 by using the formula c(k)=a(k)−K_{C}·b(k), where K_{C} is the coupling constant typically with value between 0 and 1. In this step it also calculates the average power of the noise reduced signal, P_{c}. In this embodiment Test A is true if P_{c}>T_{c}(t), where T_{c}(t) is a time-dependent threshold. Otherwise it is false. Test B utilizes the same criteria on the previous wake-sleep cycle measurements.

In another embodiment, the ambient acoustic sensor 202 is not utilized. Test A is true if Pₐ>Tₐ(t). Otherwise it is false. Test B utilizes the same criteria on the previous wake-sleep cycle measurements.

In the present description, the following definitions may be used for certain terms used therein:

ACOUSTICALLY COUPLED: Means a set of conditions wherein oscillations of matter in one body can lead to oscillations of matter in another body. The two bodies can be directly in contact with one another or there may be other intermediate bodies in between. The acoustically coupled and intermediate bodies may be solid or fluid. For example an earphone is acoustically coupled with an eardrum of the user as the oscillations of the earphone is transmitted to the eardrum. In this example the intermediate bodies are the air medium in between the two bodies and tissues near the ear.
ACOUSTIC PROXIMITY: A set of conditions wherein two devices are acoustically coupled at their respective locations.
ACOUSTIC SENSOR: A sensor that measures acoustic waves propagating in a medium in which the sensor is placed. Some non-limiting examples of the acoustic sensor are geophones, hydrophones, microphones and accelerometer.
AMBIENT ACOUSTIC SENSOR: An acoustic sensor that is utilized to measure the acoustic environment in which a wireless sensor node is placed and typically has small or no acoustic coupling to a pipeline system.
COUPLING ROD: A component placed in between a wireless sensor node and a pipeline system to enhance the acoustic coupling between the pipeline system and the acoustic sensor, as illustrated in FIGS. 3-5.
GATEWAY NODE: A node on a wireless sensor network which has a) connectivity with one or more wireless nodes in the network, and b) connectivity out of this network, typically with an operation center monitoring this network. Out-of-network connectivity can be established by various communication means such as cellular networks, Ethernet, satellite communications.
GEOPHONE: An acoustic sensor that measures ground movement. It is typically constructed by a spring mounted magnetic mass that oscillates through a wire coil, generating a voltage on the coil with the motion of the mass.
PIPELINE SYSTEM: A fluid transmission or conduit system devised to transmit fluid between two or more locations. Some non-limiting examples of pipeline systems are hydrocarbon pipeline, water distribution pipeline network system, chemical pipeline, and sewer network.
PIPELINE WARNING SIGN: A visual warning device placed in proximity to a buried pipeline to warn people of the existence of the pipeline system.
WIRELESS SENSOR NETWORK: A communications network of wireless sensors in which communication of commands and data is relayed from one wireless sensor node to another. Also located in this network is a gateway node, which has a) connectivity with one or more wireless nodes in the network, and b) connectivity out of this network. The out-of-network connectivity can be established by various communication means such as cellular networks, Ethernet and satellite communications.
WIRELESS SENSOR NODE: A node on a wireless sensor network that has radio communication with one or more nodes on the network. While a particular node may be in the range of a gateway node, which allows out-of-network communication, this is not essential to establish the communication. The wireless nodes can communicate with other nodes that are in their radio signal range and relay communications along the network until the gateway node is reached.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method of installing a leak detection system on a subterranean pipeline system, comprising:
acoustically coupling an acoustic sensor in one or more wireless sensor nodes to the pipeline system; and
and installing at least one gateway node so as to be in signal communication with at least one wireless sensor node, the gateway node in signal communication with a device external to a wireless communication network created by the one or more wireless sensor nodes and the at least one gateway node.

2. The method of claim 1, wherein the acoustic sensor comprises at least one of a geophone; a hydrophone; and an accelerometer.

3. The method of claim 1, wherein the acoustic sensor is a geophone; and the acoustic coupling is performed by inserting the geophone below a ground surface.

4. The method of claim 1, wherein the acoustic coupling is performed by inserting a coupling rod at one end thereof into contact with the pipeline system and acoustically coupling the acoustic sensor to another end of the coupling rod.

5. The method of claim 1, wherein the acoustic coupling is established by inserting a coupling rod underground and injecting an adhesive through a conduit in the coupling rod, placing the adhesive between the coupling rod and the pipeline system.

6. The method of claim 1, wherein the one or more wireless sensor nodes include an ambient acoustic sensor.

7. The method of claim 1, wherein the subterranean pipeline system is installed below a ground surface before installation of the leak detection system.

8. The method of claim 1, wherein the subterranean pipeline system is installed substantially contemporaneously with the leak detection system.

9. A leak detection system for use with a subterranean pipeline, comprising:
one or more wireless sensor nodes and at least one gateway node;
wherein each wireless sensor node comprises at least one acoustic sensor that is acoustically coupled to the pipeline; and
wherein at least one gateway node is installed within wireless communication range of the one or more of the wireless sensor nodes.

10. The leak detection system of claim 9, wherein the acoustic sensor in at least one of the wireless sensor nodes comprises at least one of a geophone; a hydrophone; and an accelerometer.

11. The leak detection system of claim 9, wherein the acoustic sensor comprises a geophone; and acoustic coupling between the acoustic sensor and the pipeline is established by inserting the geophone underground.

12. The leak detection system of claim 9, wherein the acoustic coupling is established by inserting a coupling rod underground in contact with the pipeline at one end, the coupling rod in contact with the acoustic sensor at another end.

13. The leak detection system of claim 9, wherein the acoustic coupling is established by inserting a coupling rod underground and injecting an adhesive through the coupling rod, placing the adhesive between the coupling rod and the pipeline system.

14. The leak detection system of claim 9, wherein the wireless sensor node includes an ambient acoustic sensor.

15. The leak detection system of claim 9, wherein at least one of the wireless sensor nodes comprises an optical camera.

16. The leak detection system of claim 9, wherein at least one of the more wireless sensor nodes comprises an infrared sensor.

17. The leak detection system of claim 9, wherein at least one of the wireless sensor nodes comprises an infrared camera.

18. The leak detection system of claim 9, wherein at least one of the wireless sensor nodes comprises an electrochemical sensor.

19. The leak detection system of claim 9, wherein at least one of the wireless sensor nodes comprises a temperature sensor.

20. The leak detection system of claim 9, wherein at least part of above-ground components of the wireless sensor node are attached to a warning sign.

21. The leak detection system of claim 20, wherein the at least part of the above ground components comprise an antenna.

22. A monitoring device for use with subterranean pipeline systems, comprising:
a pipeline warning sign;
at least one electronic controller having a wireless signal communicator in signal communication therewith;
at least one sensor for detecting a physical property related to a subterranean pipeline; and
wherein at least part of the wireless signal communicator is disposed on the pipeline warning sign.

23. The monitoring device of claim 22, wherein the at least one sensor comprises an optical sensor.

24. The monitoring device of claim 22, wherein the at least one sensor comprises an electrochemical sensor.

25. The monitoring device of claim 22, wherein the at least one sensor comprises an optical camera.

26. The monitoring device of claim 22, wherein the at least one sensor comprises a camera.
